(19) United States
(12) Patent Application Publication
(10) Pub. No.: US 2006/0082024 A1
(43) Pub. Date: Apr. 20, 2006

(54) Denticulation of concrete joints

(76) Inventors: Jan-Erik Nilsskog, Mosjoen (NO); Einar Lovmo, Verdal (NO)

Correspondence Address: MORGAN & FINNEGAN, L.L.P., 3 WORLD FINANCIAL CENTER, NEW YORK, NY, 10281-2101, US

(21) Appl. No.: 10/520,689

(22) PCT Filed: Jul. 4, 2003
(86) PCT No.: PCT/NO03/00239

§ 371 Date: Aug. 11, 2005

(30) Foreign Application Priority Data
Jul. 8, 2002 (NO) 20023302

(51) Int. Cl. B28B 7/20

(52) U.S. Cl. 264/318

(57) ABSTRACT

The present invention relates to a method for denticulation of a concrete cast joint between a first and a second cast section characterised by that a studded plate is used for the formwork close of the first cast section and that the studded plate is subsequently removed before the second section is cast.

The present invention relates to a method of denticulation of bridge-box in concrete joints.

### BACKGROUND OF THE INVENTION

Concrete joints normally represent a zone of weakness in terms of monolithic precast concrete. The principal object of denticulation is to reduce the degree and effect of such zones of weakness. Concrete joints will represent a section of reduced tensile strength since the bond strength in the contact surface is normally lower than the tensile strength of the concrete. The tensile strength of the joint filler will be similar to the bond strength for planar contact surfaces. A significant reduction in the proportion of contact surface in a planar section is attained by denticulation. Furthermore, the total area of contact surface is considerably greater than the area of a planar section. The degree of tensile strength weakening can thereby be reduced.

Denticulation of concrete joints in bridge constructions of concrete is normally carried out in Norway in accordance with Norwegian Standard NS3473 (Process code-2, Standard beskrivelse for bruer og kaier (“Standard Description for Bridges and Piers”), Statens vegvesen, Handbook no. 026).

It is particularly important for vertical concrete joints in the walls of balanced cantilever under a normal load situation, with tension normally on the concrete joint near the top of the box walls and with normal shear strain conditions in the midsection of the walls, that tension cracks which normally follow the concrete joint from the top down, do not continue down vertically-too far into the shear-strained area, but gradually turn aside and follow the normal line of the diagonal direction of primary tension. This is achieved if the tensile strength of the concrete joint is not significantly lower than in the rest of the concrete.

There will be a possibility of the development of a direct shear fracture with sliding between the contact surfaces, to the extent that he cracks nevertheless follow the vertical concrete joint down into areas with significant shear tension, especially if the concrete surfaces are smooth, but also between rough contact surfaces if a crack appears whose width exceeds the roughness of the surface. This type of fracture does not normally occur in reinforced concrete constructions without special weakness zones.

The primary purpose of the denticulation is therefore to ensure that the concrete joint has sufficient shear capacity under fracture limit condition even though a crack has occurred in the joint filler. The final shear capacity is particularly dependent on the magnitude of the compressive stress that acts on the joint filler simultaneously with the shear force. The denticulation will ensure that any initial sliding will lead to a crack opening, which in turn activates the reinforcement and applies pressure to the joint filler. The capacity is found to be dependent upon the relative area of denticulation. The necessary depth of denticulation is dependent upon the size of crack one must anticipate in the fracture limit condition.

The cooperation with reinforcement for the transfer of shear forces is of lesser consequence in areas with considerable stress pressure, and the denticulation or roughness of the surface will not be so critical, assuming that the contact surfaces are not polluted and are filled with full contact. The primary purpose of the denticulation is thereby to ensure that the shear strains are thoroughly distributed across the height of the construction in order that a misfortunate concentration of shear strains in the lower areas is avoided.

The current standard specifies that for more large structural components, a 48×98 mm plank with bevelled sides and a centre distance of 0.2 m as a denticulation mould in concrete joints. This provides a denticulation depth of 48 mm and minimum net cutoff area at the base of the concrete teeth equal to 98/200≈50% of the concrete area of the cast joint in the final construction. (If the denticulation is made somewhat narrower than the thickness of the concrete in order to prevent the denticulation being visible from the surface, the relative area will be somewhat-less than 50%.)

Use of wooden planks for moulding the denticulation within the cast limits is relatively labour intensive. Wooden planks of the appropriate dimensions must be bevelled on four sides and are assembled parallel to each other on a formwork foundation with correct distance between the planks. This work must be carried out accurately and thereby takes time, and leads to a lot of chippings and sawdust.

After casting, a great deal of supplementary work cleaning the denticulations of wooden splinters that remain after the planks have been removed. This is done in situ often at great height in bridge constructions where securing is necessary. The difficult and vulnerable work situation therefore leads to the danger that the denticulation will not be cleaned sufficiently well. In many cases, the plank must be knocked out with a sledge hammer, which makes it difficult to collect the waste.

It is thus a purpose of the present invention to provide a method that obviates the above disadvantages.

### PRIOR ART

A joint profile/filler profile between two cast sections where the profile is used to give a finishing treatment to a joint is disclosed in GB A 2217760, for example by injecting an expansive mass, in a “top-down” construction method where a concrete construction is cast on the underside of a higher concrete construction.

A studded plate or sheet for establishing a grip to and a seal between concrete components is disclosed in DE 132 2653977. The purpose of the invention is that the plate should be anchored to the first cast section and constitute a seal in the concrete joint.

Use of a locating profile of cellular plastic equipped with a groove to locate a waterproofing product into a casting joint has been disclosed in Norwegian NO Bi 301243. The profile leaves behind a channel-shaped groove in the concrete that forms a single denticulation when the next casting section is constructed.

The purpose of the profile according to NO 307243 is to locate a waterproofing product into a concrete joint. Meanwhile, no reference is made to strength calculations which suggest that this denticulation may be suitably employed in bridge constructions. Furthermore, the said denticulation must necessarily go through the entire concrete joint to provide a seal, i.e., in a vertical direction in a wall.

The disadvantages of the above solutions are that none of them provide the seal necessary to cope with the strains that occur in large constructions such as in a bridge, or satisfy current regulations. Formwork with special geometric properties is required for this application.

### BRIEF DESCRIPTION OF THE INVENTION

Use of a studded plate instead of a wooden plank for the formation of denticulation in the bridge-box is proposed with the intention of providing a simpler and more work environment friendly solution.

The present invention thus relates to a method of denticulation of a concrete cast joint between a first and a second cast section characterised by the use of a studded plate at the formwork termination of the first cast section and that the studded plate is then removed before the second section is cast.

The invention relates particularly to denticulation of vertical cast joints in large constructions such as box walls by sectionwise casting of balanced cantilever.

The invention regards the use of a studded plate or plate with protrusions for the denticulation formwork. This solution is simpler and more workplace environment friendly than the use of planks, and also ensures that the denticulation satisfies current regulations (NS3473).

The present invention has thus overcome a prejudice that has found its way into the current regulations, namely that bevelled planks of a given dimension must be used. Following accurate testing and calculations, the Norwegian authorities of the area have been convinced and they have now approved the use of this type of denticulation in building projects.

### SUMMARY OF THE FIGURES

FIG. 1 shows a section of an embodiment of a studded plate used in the method according to the invention.

FIG. 2 shows a top view of the studded plate shown in FIG. 1.

FIG. 3 shows a perspective view of the studded plate depicted in FIGS. 1 and 2.

FIG. 4 shows a section through a studded plate with an emphasized possible offcut area.

FIG. 5 shows a top view of the studded plate with a shaded possible offcut area.

FIG. 6 shows a graph of shear capacity of the cast seams according to the examples.

### DETAILED DESCRIPTION OF THE INVENTION

In order to describe the invention in greater detail, the invention will now be described in relation to an example embodiment. An evaluation of the geometry as well as laboratory experiments with testing of cubes of concrete were carried out in the example, both with and without a cast joint as moulded by the said studded plate. The evaluation was carried out by SINTEF and was aimed at the denticulation achieved with this type of studded plate, especially with regard to the regulations for denticulated casting joints of NS3473.

The present invention is not limited by the example embodiment.

### EXAMPLE EMBODIMENT

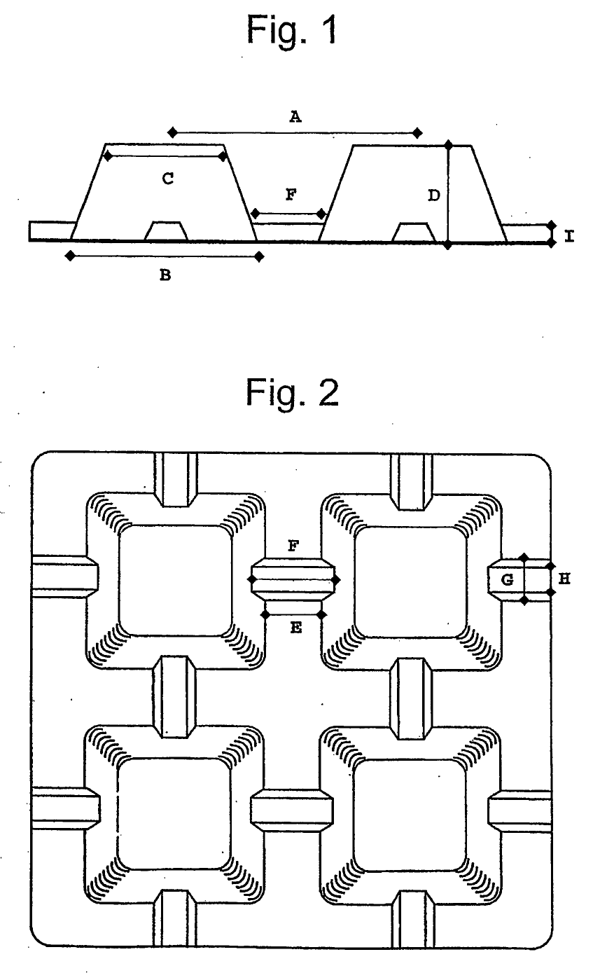

FIGS. 1 and 2 show the geometric shape of the studded plate Platon DE25, if the dimensions refer to those cited in Table 1 below.

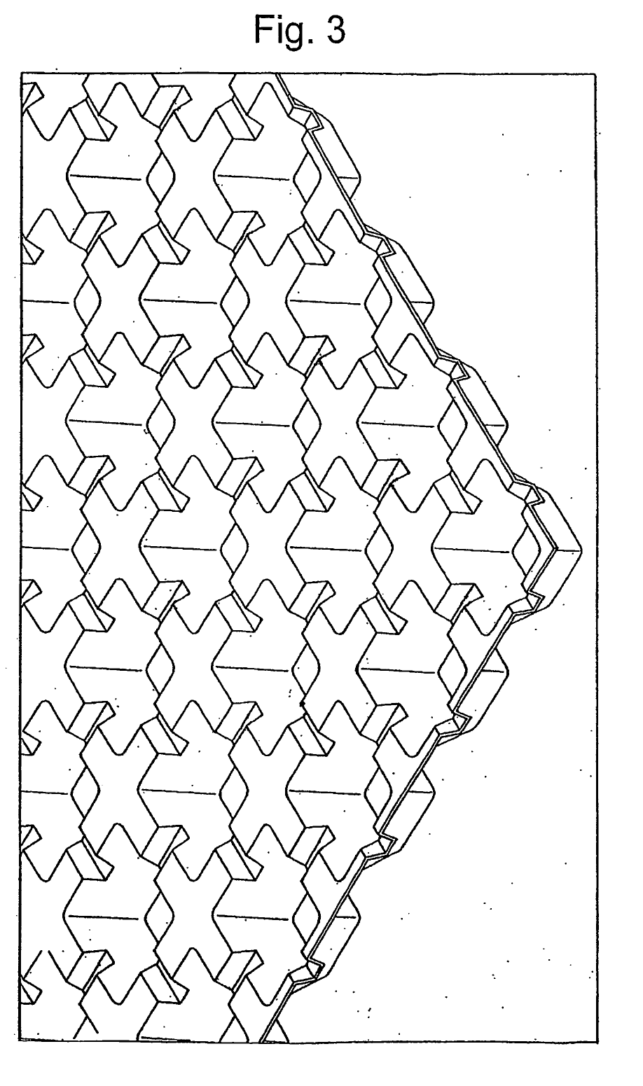

The three-dimensional shape is further depicted in FIG. 3 where the lower aspect is the aspect that is placed against the first casting section to provide the denticulation pattern.

TABLE 1
Geometry of stud pattern in Platon DE25

| | (mm) | |
|---|---|---|
| Centre distance between studs, system measurement | 55 × 55 | A |
| Lateral edge of studs at the base | 45 × 45 | B |
| Lateral edge of studs at the top | 27 × 27 | C |
| Height (depth) of the stud | 23 | D |
| Small bridges between studs: | | |
| Length at base | 10 | E |
| Length at top | 15 | F |
| Width at base | 15 | G |
| Width at top | 10 | H |
| Height | 7 | I |
| “Negative side” | | |
| Intersecting ribs between studs: | | |
| Width at top rib (valley bottom) | 10 | — |
| Bidth at base rib | 28 | — |
| Height (as studs) | 23 | — |

Capacity of Denticulated Filler According to HS3473

The shear force capacity of the denticulated casting joints were calculated according to NS3473 section 12.7 as the minimal of two appropriate combinations:
Combination 1: Pure friction model with friction coefficient μ=1.8.
Combination 2: Intercept τ_{ed}=1.5 f_{td}+friction with coefficient μ=0.8.

Combination one is appropriate for small normal stresses established by direct pressure or indirectly by activating the reinforcement that traverses the joint filler. The friction coefficient for denticulated joint filler is calculated somewhat higher than for rough surfaces (μ=1.8 instead of μ=1.5 for rough surfaces) and assumes that the denticulation satisfies the geometrical requirements as specified in the standard.

Combination 2 is appropriate for higher normal stresses. The friction coefficient is the same for rough surfaces, but the intercept τ_{vd} is considerably higher (1.5 f_{td} for rough surface). Meanwhile τ_{cd} for a denticulated surface should not be estimated as an average tension in a section through the entire denticulation area, but be presumed to act on an area corresponding to the minimum net cutoff area at the base of the denticulation. There will only be two relevant cutoff areas in normal denticulation, one tangent plane on either side of the denticulation. In normal situations where the denticulation is symmetrical and has bevelled edges, the net area through the “base” on both sides will be somewhat greater than 50% of the gross cross section. Thus denticulation also provides a moderate increase in this combination, compared to rough surface.

Evaluation of Denticulation Geometry for Joint Filler Moulded with Platon DE25

Geometrical Claims of NS3.473

The denticulation that is obtained with the Platon plate has two entirely different sides. The construction part of monolithic coherence with concrete in the main studs is referred to hereafter as the positive side. The negative side has an equivalent monolithic coherence with the volume between the studs.

The depth of the main studs and corresponding “backs” between the main studs is 23 mm and satisfies the requirement that he depth of the denticulation must be at least 10 mm. The depth of the small “bridges” between the studs is 7 mm.

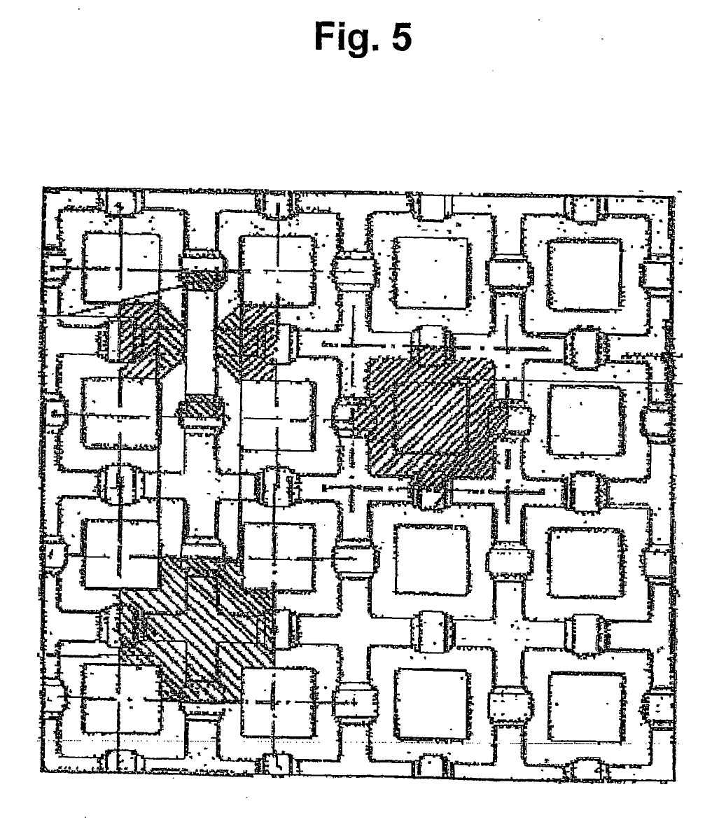

The main studs have a depth of 23 mm and length at the base of 45 mm, i.e., twice the depth. Transverse ribs between the studs have a length of 55−27=28 mm, i.e., ca. 1.2 times the depth. Longitudinal ribs are denticulated with the small bridges between the studs. It can be estimated from FIG. 5 that the bridges have a width in the base of 15 mm. The distance between them will then be 55−15=40 mm. The depth is dimensioned to 7 mm, i.e., a length/depth relation of 40/7=5,7<8. The requirement that the is denticulation shall not have a length in the direction of the force greater than 8 times the depth is therefore satisfied.

The angle of inclination of the sides of the studs is given as:
Horizontal projection: (45−27)/2=9 mm, height: 23 mm.
Angle of inclination: atan(23/9)=atan(2.55)=68°>60°. Therefore the requirement that the denticulation shall not constitute an angle less than 60° with the direction of the joint is also satisfied.
   Offcut area

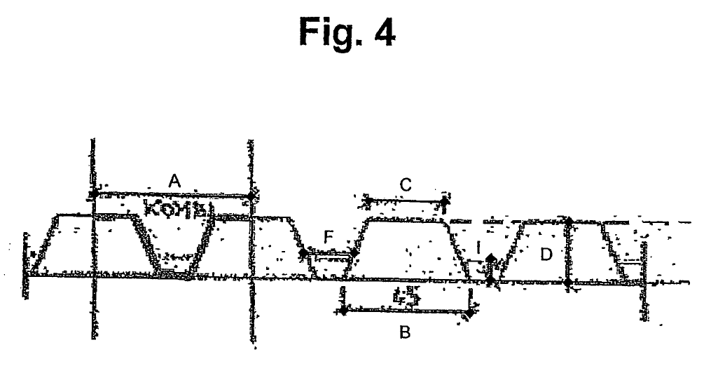

FIG. 4 shows by highlighted lines the combined shear plane that was used as a basis for the calculations below, and FIG. 5 shows shaded three possible cutoff areas within the plates system unit.

| | |
|---|---|
| System unit area: 55 × 55 = | 3025 mm |
| Positive side (base): | |
| Area of main stud at the base: 45 × 45 = | 2025 mm² |
| Area of bridges 4 half = 2 whole: 2 × 10 × 15 = | 300 mm² |
| Sum = | 2325 mm² |

The cutoff area in percent of the gross section surface:
2325/3025=76%
Negative Side (Topp):
Transverse Section in Height of the Top Surface of Studs:
Cutoff Area in Percent of the Gross Section Surface:
(3025−27×27)3025=76%
Combined Shear Plane with Force Direction in One of the Two Primary directions (Kombi):

Negative side: Cutoff of transverse rib at the same height as the top of the studs and release of longitudinal ribs by is cutting off transverse rib in the shear plane in extension of the studs side surfaces in the direction of force. Positive side: Cutting off bridges between studs under a longitudinal rib.

| | |
|---|---|
| Between stud peaks: 2 (28 × 27/2) = | 756 |
| Extension of side surfaces: | |
| 2 trapezia articles: 2 × 24(28 + 10)/2 = | 912 |
| Sum = | 1668 |
| Two half bridges: | |
| Base and sides 15 × 10 + 2 × 7(15 + 10)/2 = | 325 |
| Sum = | 1993 |

Cutoff area in percent of gross shear section:

| | |
|---|---|
| Area excluding “bridges” | 1668/3025 = 55% |
| Area including “bridges” | 1993/3025 = 66% |

Evaluation

The geometry of the primary denticulation satisfies the requirements of NS3473. The height of the small joining bridges between the studs is somewhat smaller than the formal requirement according to the standard (7 mm versus required 10 mm), but satisfy the requirement that the height shall be greater than 8 times the distance between them.

The two primary shear planes both have a favourably large relative area of 76%. This is favourable for the shear capacity, but is also favourable for the tensile strength of the filler since the area portion contact surface in a plane section is limited to 24%. The contact surface in the filler is furthermore almost double so big as a plane section through the filler.

The minimum net shear plane area was found for the combined cutoff area composed of the plane parallel cast joint and the inclining plane along the longitudinal rib. The relative area, dependent upon whether cutoff of the cross-bridges under the longitudinal ribs are taken into account or not, were 66% and 55%, respectively. The effect of the bridges is dependent upon how big a crack span one should take into account in the fracture limit condition. In thoroughly reinforced constructions, the crack span will not exceed about 2 mm as long as the reinforcement is not moved significantly even with good reinforcement dimensions. Denticulation with height 7 mm will maintain a significant part of its capacity at such a crack span.

The combined cutoff plan is only possible when the shear force is oriented in one of the stud plate's two main directions parallel to the ribs between the studs. Furthermore, denticulation by aid of the stud plate has a general advantage that it provides effective denticulation in all directions, in contrast to a traditional uniform linear denticulation. One can envisage that it would be favourable to orientate the stud plates main direction at a 45° angle with the main shear direction, but this would probably be impractical in terms of standard formats.

An overall evaluation of the geometry of the studded plate denticulation with regards the requirements of NS 3473 and simple general models for the effect in reinforced concrete constructions resulted in the primary conclusion that it will provide a-favourable denticulation that should be able to secure good tensile strength and shear transfer in accordance with NS3473 with assumed net shear area at least equal to 60%.

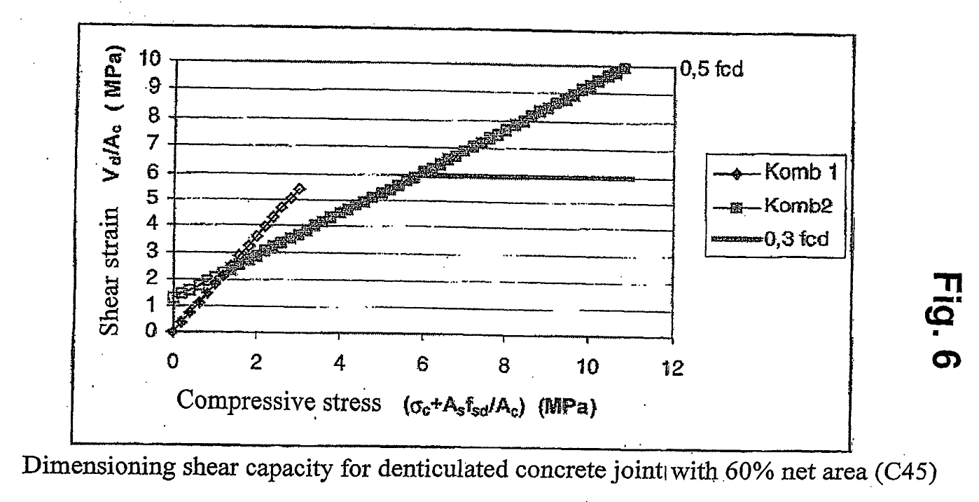

FIG. 6 shows an example of shear capacity of cast fillers in accordance with NS 2473 for concrete property class C45, i.e., f_{td}=2.0/1.4=1.43 MPa and intercept in combination 2: 0.6-1.5 f_{td}=1.29 MPa. The upper limit for the tensile strength according to NS is 0.3 f_{cd}, alternatively 0.5 f_{cd}, if the compressive stress in the filler is due to external pressure.

Testing

It is assumed that the concrete is composed such that there is a sufficient amount of mortar that the ribs, of ca. 10 min width at the top, are effectively cast.

Pressure testing of cubes with the casting joint parallel to the direction of pressure did not show any reduction in capacity compared to monobloc cubes. Indeed this was not to be expected either since the shear strain in the vertical plane through the cast joint is theoretically equal to zero. It would be difficult for a vertical split to manifest at high compressive stress in such a short test.

A bending stress experiment was carried out by testing cubes with beam load and arrangement on two supports in the form of steel bars. The investigators indicated that the tensile strength of the filler is good since the fracture did not follow the plane of the filler.

### CONCLUSION

Based on a geometric evaluation of the studded plate denticulation in relation to the requirements of NS3473 and simple general models for its effect in reinforced concrete constructions, it was concluded that the denticulation has a favourable effect on the tensile strength of the filler, and that the shear force capacity of cast joints moulded with Platon DE 25 can be calculated according to the regulations in NS3473 for denticulated surfaces with a net denticulation area equal to 60% of the gross section area.

The shape of the denticulation and case joint capacity were evaluated against the requirements of NS3473 and it was found that the requirements of the standard are satisfied. It is recommended that when used, the plate is arranged in entire stud rows symmetrically between the reinforcement layers in the bridge-box.

### ALTERNATIVE EMBODIMENTS

The studded plate may have a different geometric design in an alternative embodiment. The important factor is that the resulting denticulated joint satisfies the relevant requirements pertaining to the joint and/or satisfies the load that the joint is subjected to.

Thus it is apparent from the above calculations that a studded plate such as DE25 without bridges between the studs will manage to satisfy such requirements. The studded plate may for example have a centre distance between the studs in the range of 20-250 mm, and a stud height in the range of 5-50 mm. Furthermore, the distance between the base of the stud side walls may be in the range of 0-150 mm. The studded plates more preferably a centre distance in the range of 45-58 mm, a stud height in the range of 20-26 mm and a distance between the base of the stud side walls in the range of 5-12 mm. The positioning of the studs in relation to each other can form different patterns such as is for example square diamond design, or polygonal designs such as hexagonal, or also other symmetrical or irregular designs.

The shape of the studs can be of another type such as polygonal or round. Furthermore the studded plates may have studs where the inclining angle of the stud sidewall is greater or less than 60°.

The design of the studded plate can take any design so long as it satisfies any requirements for the joint where it is to be used and/or leads to the joint tolerating the load it will be subjected to.

In one embodiment of a studded plate without bridges, an optional channel between two rows of studs can be used to hold a hose, optionally a perforated hose, which is partly cast into the first cast section such that it remains in situ in the channel when the studded plate is removed as a membrane. The hose may optionally be used to inject a filling material into the joint.

In another alternative embodiment, the plate may be made of a material that is resistant to deformation during use, is easy to clean and which may be used again several times.

The method of the invention can likewise be used for prefabricating sections which are fitted together on site, or which are cast on site. This relates not only to construction components for bridges, but also to other areas such as in tunnels, walls for dams or tanks, or other construction components for example in buildings, such as walls, structural floors above ground, roof constructions etc.

1. A method of denticulation of a concrete joint between a first and a second cast section, wherein a studded plate is used at the formwork close of the first cast section, and that the studded plate is subsequently removed before the second section is cast.

2. A method according to Claim 1, wherein the studded plate has a centre distance between the studs in the range of 20-250 mm, preferably 45-58 mm, the height of the studs is in the range of 5-50 mm, preferably 20-26 mm, and the distance between the base of the stud side walls is in the range of 0-150 mm; preferably 5-12 mm.

3. A method according to claim 1, wherein the studded plate has studs where the stud side wall inclination angle is greater than 60°.

4. A method according to claim 1, wherein the studded plate has bridges or backs between the studs.

5. A method according to claim 1, wherein the studded plate has a shape equivalent to a Platon DE 25 studded plate.

6. A method according to claim 1, wherein the studded plate has studs that are square, polygonal or round.

7. A method according to claim 1, wherein the studded plate has studs positioned in relation to each other in a pattern, such as a square diamond, polygonal pattern such as a hexagon, or other symmetrical or irregular design.

8. A method according to claim 7, wherein the pattern is oriented parallel to or square to the direction of the primary shear.

9. A method according to claim 1, wherein the face of the studded plate toward the first cast section comprises a hose or string of swellable rubber that is partly cast into the first cast section.

10. A method according to claim 1, wherein the denticulation is done on cast joints in bridges, tunnels, or walls for buildings, dams or -containers.

11. A method according to claim 10, wherein the denticulation is done on cast joints in box walls on a free balanced cantilever.

12. A method according to claim 1, wherein the denticulation is done on site or by prefabrication of components.

13. The use of a studded plate as a formwork for denticulation of cast joints between large concrete components such as in bridges, tunnels and in the walls of buildings, dams or containers, and more particularly in boxed walls on a free balanced cantilever.

14. The use according to claim 13, where the studded plate has a centre distance between the studs in the range of 20-250 mm, preferably 45-58 mm, the height of the studs is in the range of 5-50 mm, preferably 20-26 mm, and the distance between the base of the stud side walls is in the range of 0-150 mm, preferably 5-12 mm, and even more preferably where the studded plate is a Platon DE25 plate.
